(19) United States
(12) Patent Application Publication
(10) Pub. No.: US 2010/0055990 A1
(43) Pub. Date: Mar. 4, 2010

(54) ELECTRICAL CONNECTORS

(75) Inventor: John Nigel MADELEY, Nottinghamshire (GB)

Correspondence Address: KOPPEL, PATRICK, HEYBL & DAWSON, 2815 Townsgate Road, SUITE 215, Westlake Village, CA, 91361-5827, US

(73) Assignee: Cinch Connectors Ltd., Nottinghamshire (GB)

(21) Appl. No.: 12/549,992

(22) Filed: Aug. 28, 2009

(30) Foreign Application Priority Data
Aug. 29, 2008 (GB) 0815833.9
May 15, 2009 (GB) 0908416.1

(51) Int. Cl. H01R 24/00

(52) U.S. Cl. 439/675

(57) ABSTRACT

The invention relates to a miniature electrical connector arrangement, and particularly to a socket connector for use in such a miniature connector arrangement. The socket connector comprises an outer connector body for enclosing one or more cavities. Each cavity is provided with one or more electrical contacts that can be connected to a length of one or more conductive elements. One or more flexible conductive structures are placed within the cavities and proximate to the contacts of the socket connector are capable of z-axis compressibility. The flexible conductive structures are arranged to connect to one or more pins of a plug connector of the miniature connector arrangement when the plug and socket connectors are attached with each other for conducting current.

### FIELD OF THE INVENTION

The present invention relates to electrical connectors and more particularly to miniature connectors and a method of connection for such connectors.

### BACKGROUND OF THE INVENTION

Many pieces of modern electrical equipment are now connected together using multi-way connectors in view of the need to couple a considerable number of wires, where each may be required for a particular application. Various standard systems have been utilized in the past, such as D-type connectors that are known to be used for serial connections to computers. Common D-type connectors have two rows of pins spaced approximately 0.108 inch (2.74 mm) apart, with the rows spaced 0.112 inches apart (2.84 mm). 9, 15, 25 and 37-way connectors are known.

There is often a requirement that the connectors should be as small as possible and this has put considerable constraints on the ability of assemblers to physically make connection between connector pins and sockets and between the wires of a cable and the pins or sockets of a connector part. The problems are exacerbated if the connector has to be suitable for use in a hostile environment where it may be subjected to substantial amounts of vibration, or if it has to carry a large amount of current in relation to the pitch and physical size of the contacts.

Miniature connectors such as micro-miniature D-type connectors, i.e. connectors having contact spacing between the pins or sockets of about 0.050 inches or 1.27 mm (i.e. 0.050 inch pitch connectors), are prone to the above-mentioned problems owing to their small size. This is especially so in nanominiature connectors i.e. connectors having contact spacing between the pins or sockets of about 0.025 inches or 0.635 mm (i.e. 0.025 inch pitch connectors) or connectors of a smaller size. These connectors tend to be limited in their current carrying capacity, and yet are frequently required because many applications need small connector arrangements. Owing to their small size and fragility, there is a risk of disconnection or damage to nanominiature connector arrangements, and this is unacceptable for some critical applications such as in military and aerospace applications. This is especially true in the case of hostile environments that are subjected to shock and vibration.

Nanominiature connectors are generally known to be rated at 1 ampere, which is typical of connectors complying with the ISO standard MIL-DTL-32139 for military applications. As mentioned above, nanominiature connectors can in many cases be intended for critical applications where other types of connectors are either too large or unsuitable for particular applications. Typical applications for such connectors include miniaturized electronics boxes used in Unmanned Aerial Vehicles, satellites, missile systems and geophysical instruments. Contact spacing of 0.025 inches (or 0.635 mm) between the pins in the connectors combined with a rugged contact system allow nanominiature connectors to be used in demanding environments where size restrictions will not allow most other connectors.

There are a number of types of nanominiature connectors currently being used. One such implementation is a twistpin-tubular socket pair connector arrangement as shown in FIG. 1. Here, the pin is made up of wires that are bulged together to create a spring. This is then crimped to a tubular sleeve that allows the pins to be crimped to the conductive wiring.

Another type of nanominiature connector is a pin contact having spaced tines that allows this connector to act as a spring member. This is shown in FIG. 2. The socket contact shown as (b) in this figure for use with a pin contact (a) is a tubular member. There are usually 3 or 4 tines for the pin, sometimes more. The low mass and the plurality of tines ensure that there is an effective wiping action when in contact, which reduces the risk of interruption of contact during shocks and vibrations that occur in hostile environments.

A further implementation is a cantilever spring pin that uses a two-leaf design wherein one leaf of each part of the connector is fixed while the other end is floating and rests against the tip of the opposing leaf. This is shown in FIG. 3.

All of the above described nanominiature connectors use ‘pin and socket’ type contacts that are self-retaining when in contact with each other due to the engagement force when a resilient pin is squeezed inwards to fit within a socket. These existing contacts provide gripping forces that hold the contact together when they carry current, such that there is no interruption on current flow during vibrations and shocks in hostile environments. However, it will be seen that all of the above described nanominiature connectors have modifications or re-structuring of the pins of the plug contact i.e. twisted-wires or tines or leaf arrangements that provide this gripping action.

### SUMMARY OF THE INVENTION

An aspect of the present invention provides a socket connector for use in a miniature connector arrangement, said socket connector comprising a connector body enclosing one or more cavities, each cavity having one or more electrical contacts that are capable of being connected to a length of one or more conductive elements, wherein said socket connector comprises one or more flexible conductive structures placed within the one or more cavities such that the flexible conductive structures are proximate to the electrical contacts and arranged to be electrically coupled therewith, said flexible conductive structures being arranged to be electrically coupled with one or more pins of a plug connector of the miniature connector arrangement.

The flexible conductive structures are preferably compressible in the direction of the longitudinal axis of a socket, and are compressed by insertion of pins into the sockets. The resilience of the compressed flexible structures helps to maintain physical contact between the flexible structures and the inserted pins, thereby maintaining electrical contact. This allows solid pins to be used in the pin and socket arrangement, increasing the current carrying capability of the pins compared with known modified pins.

The present invention can be implemented to provide a miniature connector arrangement which is suitable for producing a mating pin and socket for use in a hostile environment, where they are subjected to substantial amounts of vibration, and where the contacts can carry a large current in proportion to the contact size and pitch. Nanominiature connectors of 0.025 inch pitch or even connectors of a smaller scale can be used. Furthermore, larger connectors of pitch such as 0.030 inch or larger can also benefit from the insertion of longitudinally-compressible conductive structures into a socket to maintain electrical connection for a pin and socket connection.

The present invention provides a miniature connector, and preferably nanominiature connectors, wherein solid conductive pins can be used in the plug contacts. The invention relates to a nanominiature connector arrangement wherein a flexible conductive structure is placed in cavities in the socket contact and the pins of the plug are inserted into the cavities so that the pins press against the conductive structure. This compresses the flexible conductive structure. In this compressed state, the resilience of the flexible conductive structures biases the structures outwards to their uncompressed state, and this spring operation in the longitudinal direction of the socket retains physical contact between the socket contact and the conductive pins despite relative movement in response to vibrations or thermal expansion, and slight variations in component size or tightness of connection. The plug and socket connectors when in a mated state are held in position by a known locking or latching mechanism, or retained by epoxy.

The contacts of the present invention are held together against axial forces resulting from the resilience of the flexible conductive structures held in place by a known locking mechanism, or retained by epoxy. This causes the plug and socket elements to self-eject when released. Since solid pins are capable of being used, such a connector arrangement according in the present invention can carry more current than most nanominiature connectors do. Currents up to 1.8 amp or more can be carried in such nanominiature connectors and these connectors can withstand electrical break-down better than existing nanominiature connectors. Electrical properties similar to that of a micro-miniature connector, i.e. a 0.050 inch pitch connector in line with ISO military standard MIL-DTL-83513, may also be achieved by a nanominiature connector arrangement according to the present invention.

### BRIEF DESCRIPTION OF THE DRAWINGS

Embodiments of the invention are described below in more detail, by way of example, with reference to the accompanying drawings in which:

FIG. 1-3 show implementations of known nanominiature contacts;

FIG. 4 shows an example of a known flexible conductive structure (CIN::APSE®) used to connect substrates of Printed Circuit Boards (PCB's);

FIG. 5(a) shows a diagrammatic sectional side view of a Plug and Socket connector before mating with each other according to the nanominiature connector arrangement of the present invention.

FIG. 5(b), shows a diagrammatic sectional side view of a Plug and Socket connector according to the present invention, after mating with each other. Both the Plug and Socket connectors are attached to the ends of wires.

FIGS. 6(a) and 6(b) show examples of connector arrangements according to the present invention, including a locking mechanism for the arrangement of FIG. 6(a), in an unlocked state.

FIGS. 7(a) and 7(b) show examples of connector arrangements according to the present invention, along with a locking mechanism for the arrangement of FIG. 7(a), in a locked state.

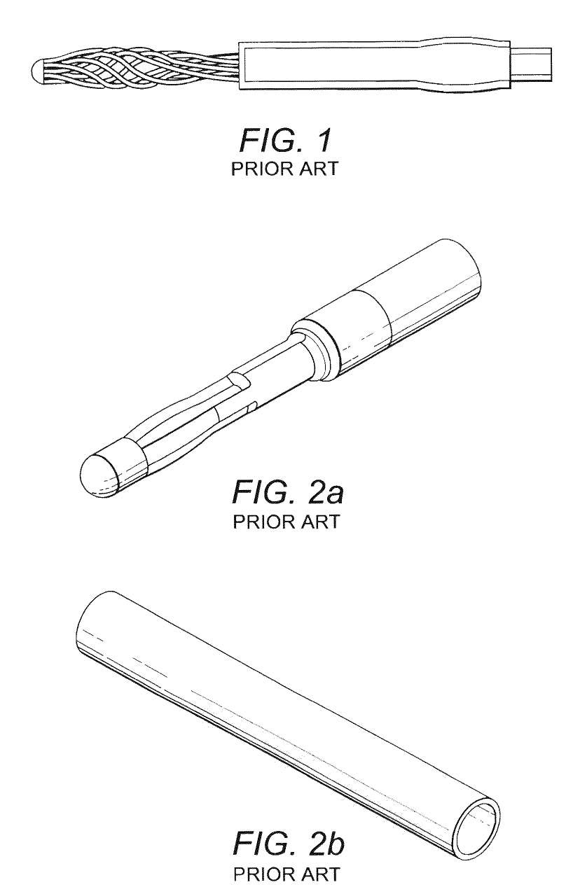

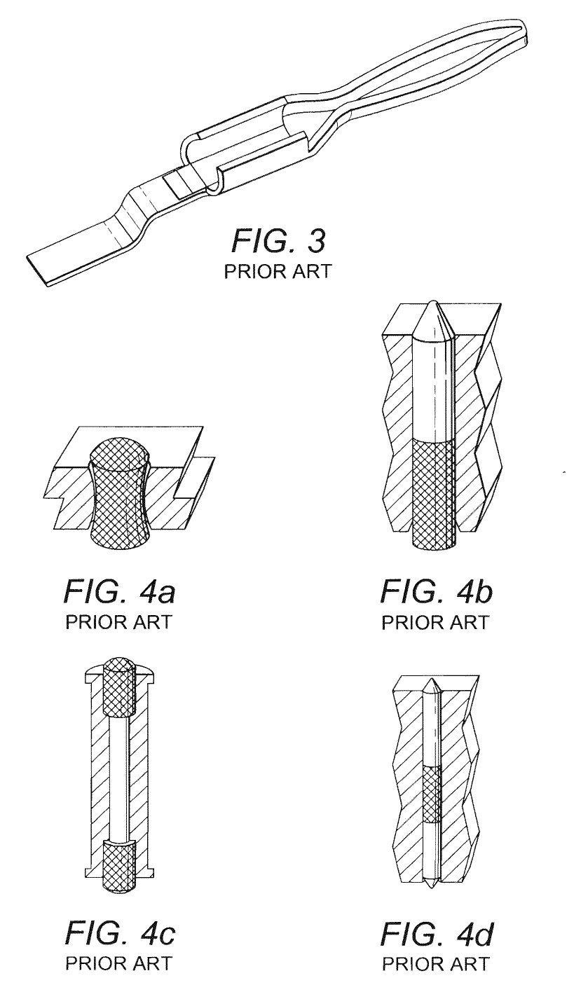

### DETAILED DESCRIPTION OF THE INVENTION

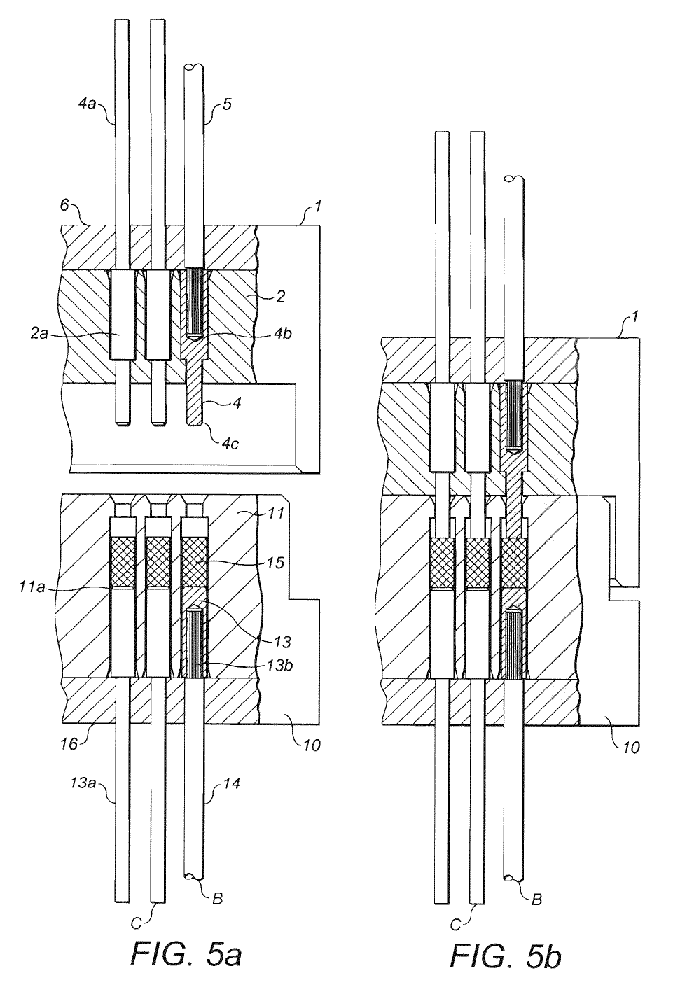

An aspect of the nanominiature connector arrangement of the present invention is shown in FIGS. 5a and 5b. The advantage of this arrangement is that higher current flows can be achieved since it is possible to use basic solid turned contacts, which are crimped or soldered to wires, without requiring any modification in the pins or the sockets for providing the additional grip. This is achieved by including a flexible conductive structure interposed between these contact faces. This flexible structure of the present invention is formed of highly conductive material i.e. having highly conductive wires or other conductive means.

This structure acts as a z-axis compression interconnect between the plug and socket connectors. The Z-axis compression interconnect device provides a force in the direction of the longitudinal axis (i.e. the z-axis direction) of the pins of the plug and the socket contacts when these are held in a mated state. This z-axis compressibility in interconnection devices is previously known to electrically connect two parallel planar surfaces together, such as to connect two printed circuit boards (PCB) or other components to a PCB such as a chip-to-board interconnect. An aspect of present invention using a conductive flexible structure in plug and socket connectors is not seen or derived from the prior art, and represents a significant change from known arrangements using modified pins.

An implementation of a flexible conductive material is in the form of a compressible ‘contact’ structure. Elastic solder-less ‘contact’ structures providing z-axis compressibility include the CIN::APSE® structure (manufactured by Cinch).

The CIN::APSE® structure is shown in FIG. 4 when used in four different implementations for electrical connection between planar surfaces. FIG. 4 (a) shows a basic CIN::APSE® contact configuration. It is ideally suited for applications requiring minimum height, high density, and signal integrity. This configuration can also be used in land grid arrays (LGAs), flexible-circuits, chip package to PCB or component to PCB. In FIG. 4(b), the addition of a plunger increases the durability of the CIN::APSE® contact while also achieving additional height. This configuration is ideally suited for interconnection applications and those that require additional handling. In FIG. 4(c), the use of two CIN::APSE® structures with a spacer in between creates a connector with all the benefits of the implementation seen in FIG. 4(a), but with the ability to span greater z-axis heights. This configuration is used where the CIN::APSE's® multiple points of contact are needed. In FIG. 4(d), the addition of a second plunger to the connector results in the most durable system and providing additional height. This configuration is best suited where both sides of the contact will see additional handling. Despite these various arrangements, they are all intended for providing an electrical connection between two planar surfaces. No similar arrangements are known to manufacturers of nanominiature plug and sock arrangements. Nanominiature plug and socket arrangements have not previously employed z-axis compressible conductive structures according to the present invention.

The CIN::APSE® structure is known to be manufactured by randomly winding gold plated molybdenum or tungsten wire into a cylindrical structure. The structures are then placed within a suitable insulating material. The diameter of this structure currently used in circuit board technology is about 0.020 inch to 0.040 inch in diameter. The inventors of the present invention have determined that such of a structure can be scaled down to an appropriate size for use in nanominiature or smaller sized connector arrangements for plug and socket arrangements.

The CIN::APSE® is just one example of a flexible conductive structure that may be used for the present invention. The compressible feature of this structure allows the CIN::APSE® to be firmly held in position under compression. The CIN::APSE® contact allows electrical elements to remain in contact even under extreme Thermal Expansion mismatch. The CIN::APSE® has a high modulus of elasticity which means the structures can be compressed thousands of times. These structures are also very lightweight and thermally stable which makes them extremely resistant to intermittent signals caused by shock/vibration or thermal cycling. The CIN::APSE® provides several (typically 7-11) points of electrical contact at each end. This structure's multiple points of contact from its randomly wound wires function similarly to several independent spring based electrical contacts. Its superior electrical characteristics include a short signal path with extremely low inductance and resistance.

The above-mentioned feature makes the CIN::APSE® ideal for use as the flexible conductive structure in the nanominiature contacts of the present invention. It is to be appreciated that other types of flexible conductive structures and materials may also be used to implement the present invention. The invention is not limited to a structure formed of randomly wound wires, such as described above.

Another example of a z-axis compression interconnect structure is the iQ® structure (described in U.S. Pat. No. 6,921,270 and others). This is a robust interconnect for circuit board technology that is shaped similar to the letter ‘Q’ and is capable of high-speed electrical performance. The high density of the ‘iQ’ structure makes it suitable for use as an interconnection device in land grid arrays (LGA's), Component-to-Board design, Board-to-Board design etc. This compressible structure provides a top to bottom conductive path that when compressed results in a short electrical path of low inductance that allows for high-speed solutions. The shape is such that it can be used in uneven board plans for connecting the electrical elements of the PCB's together. This stamped and formed z-axis compression interconnect is known to be used for circuit boards. As mentioned above, the prior art does not teach or suggest that z-axis compressibility has been used in a cable or a plug and socket wired connection arrangement for miniature connectors. The inventors of the present invention have determined that the iQ® can be scaled down to an appropriate size for miniature plug and socket arrangements, and so this structure can also be used to implement the flexible conductive structures of the present invention.

An embodiment of the invention provides the inclusion of a flexible conductive structure in the socket connector of a ‘plug and socket’ type of nanominiature connector arrangement, wherein conductive elements such as one or more wires are attached to the pins of the plug connector and to the contacts of the socket connectors via the flexible conductive structures.

The miniaturization of conductors of the present invention can be scaled down to 0.635 mm (0.025 inches) ‘nano’ pitch or even smaller. The flexible conductive structure provides multiple points of contact to the contact faces in the pins of the plug and the contacts in socket, thus ensuring continuous connection between these elements during vibration or shock because of the compressive forces that hold the pins and contacts in connection with each other. Such type of flexible structure can operate with solid contact pins and carry a higher current than twisted-pin type or leaf-type contacts of a similar size.

One embodiment of the structure of the nanominiature connector arrangements of the present invention can be seen in FIGS. 5(a) and 5(b).

Referring to FIGS. 5(a) and 5(b), these figures show a sectional view of a part of the nanominiature connector arrangement of the present invention. In FIG. 5(a), the arrangement is shown in its unplugged state. In this figure, a Plug connector 1 comprises a main connector body 2, which is capable of being enclosed in a shell that is preferably made of metal (The enclosure is not shown in the figures). The main connector body 2 is provided with a plurality of contact cavities 2a.

Located in the main connector body 2 are a plurality of pins 4 to which one or more wires 5 or a length of solid wire 5 can be connected by means of crimping, soldering or other suitable attachment methods. The pins 4 are made up a conductive material such as metal. To hold the pins 4 in position and provide environmental protection, a layer of epoxy 6 or any other suitable protective layer may be provided above the protruding plug pins.

A socket connector 10 of the nanominiature connector arrangement comprises three parts, namely a main connector body 11, which is capable of being enclosed in a shell that is preferably made of metal (The enclosure is not shown in the figures). The main connector body 11 is provided with a plurality of contact cavities 11a.

Located within the main connector body 11 for the socket connector, proximate to the contact cavities 11a are a plurality of metal contacts 13 to which the wires 14 or a length of solid wire can be connected by means of crimping, soldering or other suitable attachment methods.

A plurality of flexible conductive structures 15 are provided within the cavities 11a of the socket connector. These structures may be in the form of highly conductive structures such as the CIN::APSE® structures described above or any other form of compressible conductive materials such as elastic/resilient conductors etc. These structures 15 provide z-axis compressibility between the pins of the plug and the socket connectors such that the plug and socket are held against compressive forces of these structures 15. To hold the contacts 13 in position and provide environmental protection is a layer of epoxy 16 or any other suitable protective layer may provided on the outer surface of the socket. Known components common to a plug and socket connector, for example tapped holes, or threaded inserts etc. (not shown) may be integral to Plug connector 1. Similarly, known components such as captive jackscrews etc. (not shown) may be integral to Socket connector 10.

The connection for the nanominiature electrical connector arrangement of the present invention is described below.

FIG. 5(b) represents the nanominiature connector arrangement of the present invention in its plugged state, i.e. connected state.

The connector arrangement of FIGS. 5(a) and 5 (b) are formed as described below:

When crimped contacts 4a are to be fitted in the plug connector 1, then the wire insulation may be cut back to expose the stranded wires to be crimped in a contact barrel 4b. This view with the insulation cut back can be seen in pin and socket pair B. Pair C shows a view of the pin and socket pair without the insulation being shown.

The contacts 4a with crimped wires are inserted into cavities 2a in the connector body 2. The pin ends 4c protrude through the main connector body 2. The contacts 4a are then held in place in the connector body 2 by a layer of epoxy 6, which is usually cured/hardened. Any other protective layer may also be used instead of epoxy resin.

As with the plug connector, it is assumed that when crimped contacts 13a are to be fitted in the socket connector 10, then the wire insulation may be cut back to expose the wire(s) to be crimped in a contact barrel 13b.

The flexible conductive structures 15 are inserted into the cavities 11a within the connector body 11. The contacts 13a with crimped wires are inserted into the cavities 11a in the connector body 11 and abut the flexible conductive structures 15. The contacts 13a are then held in place in the connector body 11 by a layer of epoxy 16 which is usually cured or hardened. Any other protective material other than epoxy resin may be used.

The plug and socket connectors 1 and 10 are mated together as shown in FIG. 5(b). (Usually jackscrews in the plug are tightened into the tapped holes or threaded inserts present in the Socket). This action presses the pin ends 4c against the highly conductive flexible structures 15 in the socket cavities 11a and compresses them. The flexible conductive structures provide z-axis compressibility between the plug and socket connectors. The plurality of the contact points of these flexible conductive structures 15 against the pin end 4c ensures good electrical conductivity and no risk of disconnection even under extreme vibration or shock owing to the axial compressive forces that the pins and contacts are held against.

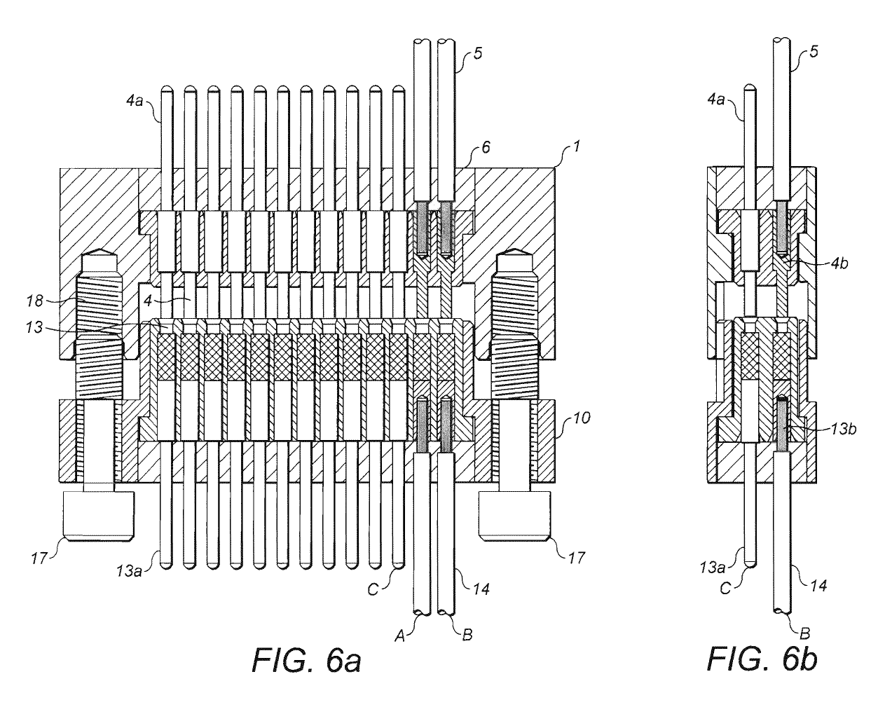

FIG. 6(a) shows a miniature connector arrangement with a plug connector (1) and socket connector 10 having 13 pins and 13 sockets respectively. The same reference numerals as in FIGS. 5(a) and (b) are used in this figure since these 13 pairs of pins and sockets are based on the embodiments described in FIGS. 5(a) and (b). The plug connector 1 and the socket connector 10 of the arrangement are held together by a locking mechanism. This mechanism shown in this figure is in the form of a bolt 17 that can be retained in a retaining element 18. In this figure, the bolt 17 is shown as being part of the socket connector 10 with the retaining element for it being in the pin connector 1. Here, the connector arrangement is shown in its unlocked state with both connectors being apart from each other. The arrangement of the individual pairs of pin and socket contacts in an unlocked state can also be seen. The pairs A and B are depicted with the insulation of conductive wires 5 and 14 cut back so that the crimped contacts that form the pins 4 and sockets 13 can be seen. Pair C is a view of a pin and socket without the cut back insulation. The differing views, Band C of the pin and socket pairs are clearly seen in FIG. 6(b).

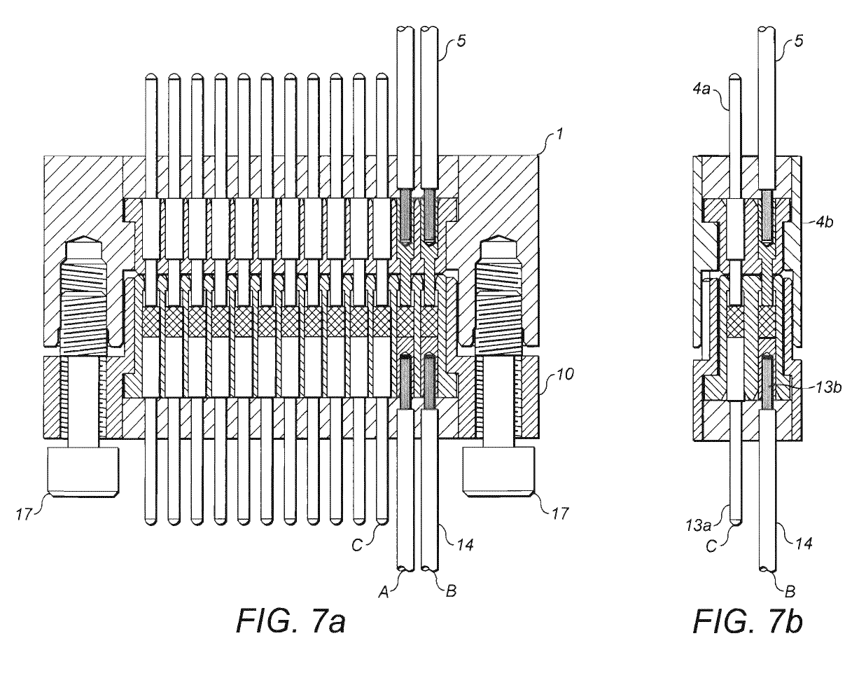

FIG. 7(a) shows a miniature connector arrangement according to the present invention wherein the locking mechanism is in its locked state. Bolt 17 locks the socket connector 10 in place with the retaining element 18 of the pin connector 1. The arrangement of the individual pairs of pin and socket contacts in a locked state is seen in this figure. The pairs A and B are depicted with the insulation of conductive wires 5 and 14 cut back so that the crimped contacts that form the pins 4 and sockets 13 can be seen. Pair C is a view of a pin and socket contact without this cut back insulation. The differing views B and C of the pin and socket pairs can also be seen in FIG. 7(b).

Pair D is shown pictorially to demonstrate the uncompressed length of flexible structure 15 as compared to the compressed length of flexible structure 15 as shown for example in Pair C.

It will be appreciated that the locking mechanism is not limited to a bolt and a retaining means, but may be any means that can be used to fasten the plug and socket connector together. This locking mechanism may also be a screw arrangement or a latching means. These may also be locked together by encapsulating the connectors in epoxy resin or any other similar material.

As mentioned above, the CIN::APSE® is ideal for use as the z-axis compressible structures for nanominiature plug and socket connectors. Since this structure is made up of a mass of wire, the scaling down to an appropriate size for nanominiature connectors or an even smaller size is easily possible by adjusting the wire diameter accordingly during manufacture. This structure, being a solid resilient mass is more reliable in its miniature form rather than other known stamped and formed or leaf contacts that could have the risk of breakage when scaled down to miniature sizes.

Further, since the plug pins and socket contacts 4 and 13 used with the invention can be solid conductive features, requiring no structural modification and since the flexible conductive structure 15 is a whole mass of conductive wire, the current carrying capacity of the connection is much greater than conventional miniature connectors.

1. A socket connector for use in a miniature electrical connector arrangement, said socket connector comprising a connector body enclosing one or more cavities, each cavity having one or more electrical contacts that are capable of being connected to a length of one or more conductive elements, wherein said socket connector comprises one or more flexible conductive structures placed within the one or more cavities such that the flexible conductive structures are proximate to the electrical contacts and arranged to be electrically coupled therewith, said flexible conductive structures being arranged to be electrically coupled with one or more pins of a plug connector of the miniature connector arrangement.

2. The socket connector as claimed in claim 1 wherein said flexible conductive structures are capable of providing z-axis compressibility between the plug and socket connectors.

3. The socket connector as claimed in claim 2 wherein said flexible conductive structures are made up of a compressible mass of highly conductive wires.

4. The socket connector as claimed in claim 2 wherein said flexible conductive structures are conductive elastic structures.

5. The socket connector as claimed in claim 1 wherein said connector is a nanominiature socket connector.

6. A miniature electrical connector arrangement comprising a socket connector as claimed in claim 1, the connector arrangement further comprising a plug connector that is capable of being connected to the socket connector to conduct current, said plug connector comprising a connector body having one or more cavities, each of said cavities are adapted to hold an electrically conductive pin such that said pin protrudes outside the connector body, each pin is capable of being connected to a length of one or more conductive elements.

7. The miniature connector arrangement as claimed in claim 6 wherein said pins of the plug connector are electrically coupled to the flexible conductive structures of the socket connector when both connectors are connected to each other, such that current is conducted via said flexible conductive structures.

8. The miniature connector arrangement as claimed in claim 7 wherein said flexible conductive structures exert a z-axis compressive force against the pins and the electrical contacts when the plug and socket connectors are connected to each other by a locking means, such that accidental disconnection of the pins and socket contacts is avoided.

9. The miniature connector arrangement as claimed in claim 6 wherein the flexible conductive structures provide several points of electrical contact between the pins and socket contacts.

10. The miniature connector arrangement as claimed in claim 6 wherein said socket connector and plug connector are arranged to be fastened to each other by a locking means.

11. The miniature connector arrangement as claimed in claim 6 wherein said arrangement is a nanominiature electrical connector arrangement.
